(19) United States
(12) Patent Application Publication
(10) Pub. No.: US 2007/0009686 A1
(43) Pub. Date: Jan. 11, 2007

(54) RECORDING MEDIUM

(75) Inventors: Sebastianus Gerardus, J.,M. KLUIJTMANS, Zeist (NL); Jacko Hessing, Rijen (NL); Huibert Albertus van Boxtel, Tilburg (NL); Akira Kase, Tilburg (NL)

Correspondence Address: BANNER & WITCOFF, LTD., 28 STATE STREET, 28th FLOOR, BOSTON, MA, 02109-9601, US

(73) Assignee: Fuji Photo Film B.V., Tilburg (NL)

(21) Appl. No.: 11/460,452

(22) Filed: Jul. 27, 2006

Related U.S. Application Data
(63) Continuation of application No. PCT/NL05/00074, filed on Feb. 2, 2005.

(30) Foreign Application Priority Data
Feb. 2, 2004 (EP) 04075297.4
Feb. 2, 2004 (EP) 04075298.2

(51) Int. Cl. B41M 5/40

(52) U.S. Cl. 428/32.34

(57) ABSTRACT

The present invention relates to a recording medium, in particular an ink-jet recording medium of photographic quality that has excellent lightfastness. According to the present invention an ink-jet recording medium is provided, comprising a support and an ink-receiving layer adhered to said support, wherein the ink-receiving layer is a multilayer comprising a top layer, which top layer comprises a modified gelatin, and at least one intermediate layer in between said support and said top layer, wherein said intermediate layer comprises a mixture of a PVA-based polymer and a water soluble polymer. The present invention is further directed to methods for obtaining and using such a medium.

### RELATED APPLICATIONS

This application is a continuation of PCT application no. PCT/NL2005/000074, designating the United States and filed Feb. 2, 2005; which claims the benefit of the filing date of European application nos. EP 04075297.4, filed Feb. 2, 2004; and EP 04075298.2, filed Feb. 2, 2004; all of which are hereby incorporated herein by reference in their entirety.

### FIELD OF INVENTION

The present invention relates generally to a recording medium, in particular an ink-jet recording medium of photographic quality that has excellent ink absorption speed, good drying characteristics and a good image printing quality, in particular an improved lightfastness, as well as to methods for preparing and using such media.

### BACKGROUND OF THE INVENTION

In a typical ink-jet recording or printing system, ink droplets are ejected from a nozzle at high speed towards a recording element or medium to produce an image on the medium. The ink droplets, or recording liquid, generally comprise a recording agent, such as a dye, and a relatively large amount of solvent in order to prevent clogging of the nozzle. The solvent, or carrier liquid, typically is made up of water, and organic material such as monohydric alcohols and the like. An image recorded as liquid droplets requires a receptor on which the recording liquid dries quickly without running or spreading. High quality image reproduction using ink-jet printing techniques requires receptor substrates, typically sheets of paper or opaque or transparent film, that readily absorb ink droplets while preventing droplet diffusion or migration. Good absorption of ink encourages image drying while minimizing dye migration by which good sharpness of the recorded image is obtained. In many recording media inorganic microporous particles in combination with a binder are applied to achieve good drying properties. Examples of such particles are silica, alumina and pseudo-boehmite as described in e.g. EP-A-0 761 459, EP-A-1 000 767 and EP-A-1 306 395.

A further important property of inkjet media is that they should provide for a good lightfastness, viz. the printed images must not fade over longer periods of time.

In order to improve the lightfastness of inkjet media, several approaches have been suggested in the prior art. JP-A-4 201 594, for instance, suggests to include hyperfine powder of specific transitions metal oxides into one or more layers and GB-A-2 147 003, for instance, suggests to combine metal salts with cationic polymeric substances to improve lightfastness of the produced images. Furthermore, JP-A-2002/220 559 and EP-A-0 869 010 describe a specific copolymer, which is to be included in one or more of the layers of the inkjet media, to improve lightfastness.

JP-A-2000/280 601 discloses inkjet recording media wherein the lightfastness is improved by incorporating a UV absorbent in a protective layer of the media.

WO-A-03/054029 describes poly(vinyl alcohol)-co-poly(n-vinyl formamide) copolymers (PVA-NVF) for use in inkjet recording media. The inkjet recording media of this document are said to have improved image permanence against the harmful effects of light and/or atmospheric pollutants.

Another important aspect of recording materials is their gloss. When the lightfastness is to some extend improved, it still remains a problem to maintain the gloss on an acceptable level, while maintaining at the same time good drying properties together with acceptable whiteness, good image printing quality, good curl and brittleness. Also at the same time the recording materials should have good behaviour on bleed, beading and matte appearance in particular at the high density parts of the recording materials. Further the recording materials should be available at low cost.

Thus there remains a need for ink-jet materials having good lightfastness and good gloss keeping at the same time good physical properties as mentioned above. It is towards fulfilling these needs that the present invention is directed.

### SUMMARY OF THE INVENTION

The object of the present invention is to provide a recording medium having good overall properties, said recording medium more in particular being suited to produce images of photographic quality, wherein said medium has an improved lightfastness.

It is a further object of this invention to provide an ink jet recording medium where the medium has an improved lightfastness and a good gloss.

At the same time it is desirable that the media of the present invention maintain other favourable properties with respect to good drying properties, acceptable whiteness, good image printing quality, good curl and brittleness, having at the same time good behaviour on bleed, beading and matte appearance at high density parts.

It was found that these objectives can be met by providing a recording medium comprising a support and an ink-receiving layer adhered to said support, wherein the ink-receiving layer is a multilayer comprising a top layer (viz. the layer furthest away from the support) which top layer comprises a modified gelatin, and at least one intermediate layer in between said support and said top layer, wherein said intermediate layer comprises a mixture of a poly vinyl alcohol (PVA)-based polymer and a water soluble polymer.

### DETAILED DESCRIPTION

The invention is directed to a recording medium comprising a support and an ink-receiving layer adhered to said support, wherein the ink-receiving layer is a multilayer comprising a top layer which top layer comprises a modified gelatin, and at least one intermediate layer in between said support and said top layer, wherein said intermediate layer comprises a mixture of a poly vinyl alcohol (PVA)-based polymer and a water soluble polymer.

In general a large variety of PVA-based polymers can be used, such as fully hydrolysed or partially hydrolysed PVA, carboxylated PVA, acetoacetylated PVA, quaternary ammonium modified PVA, copolymers and terpolymers of PVA with other polymers, or combinations thereof, but the preferred PVA-based polymers are those which have been modified to give a good miscibility with water and water soluble polymers. The PVA-based polymer used in accordance with the present invention is preferably a poly(vinyl alcohol)-co-poly(n-vinyl formamide) copolymer (PVA-NVF). Very suitable PVA-NVF copolymers for use with the present invention are the copolymers described in WO-A-03/054029, which have the general formula I:

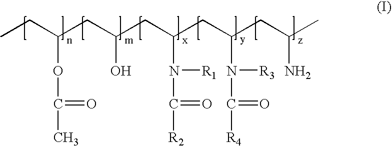

wherein

n is between 0 and about 20 mole percent;

m is between about 50 and about 97 mole percent;

x is between 0 and about 20 mole percent;

y is between 0 and about 20 mole percent;

z is between 0 and about 2 mole percent and

x+y is between about 3 and about 20 mole percent;

R₁, and R₃ are independently H, 3-propionic acid or C₁-C₆ alkyl ester thereof, or is 2-methyl-3-propionic acid or C₁-C₆ alkyl ester thereof; and

R₂ and R₄ are independently H or C₁-C₆ alkyl.

By applying the preferred PVA based polymer the light fastness of the printed image on the recording media is very much improved. The PVA-based polymer(s) are preferably applied to the substrate in an amount ranging preferably from 0.5 until 15 g/m² and more preferably from 1.0 until 10 g/m².

Gelatin is preferably chemically modified at its reactive groups (COOH, NH₂). The modified gelatin used according to the present invention preferably refers to gelatin compounds in which at least part of the NH₂ groups is chemically modified. A variety of modified gelatins can be used like phthalated and acetylated gelatins and the like. Good results are obtained, when at least 30% of the NH₂ groups of the gelatin is modified by a condensation reaction with a compound having at least one carboxylic group as described among others in DE-A-19721238. The compound having at least one carboxylic group can have an other functional group like a second carboxylic group and a long aliphatic tail, which in principle is not modified. Long tail in this context means from at least 5 to as much as 20 C atoms. This aliphatic chain can be modified still to adjust the properties like water solubility and ink receptivity. Specially preferred gelatins of this type are succinic acid modified gelatins in which the succinic acid moiety contains an aliphatic chain from at least 5 to 20 carbon-atoms, where the chain can still be modified to a certain extend to adjust the water soluble properties or ink receptive properties. Most preferred is the use of dodecenylsuccinic acid modified gelatin, in which at least 30% of the NH₂ groups of the gelatin have been modified with said dodecenylsuccinic acid.

Other suitable methods for obtaining the modified gelatin are described in EP-A-0 576 911, by V. N. Izmailova, et al. (Colloid Journal, vol. 64, No. 5 (2002), pages 640-642), and by O. Toledano, et al. (Journal of Colloid and Interface Science, vol. 200, (1998), pages 235-240).

Other suitable modified gelatins giving good results are gelatins modified to have quaternary ammonium groups. An example of such a gelatin is the “Croquat™” gelatin produced by Croda Colloids Ltd.

Water soluble polymers that may be used in the present invention include: fully hydrolysed or partially hydrolysed polyvinyl alcohol, hydroxyethyl cellulose, methyl cellulose, hydroxypropyl cellulose, polyvinylpyrolidone, any gelatin whether lime or acid treated bone or hide gelatin of pig or cattle or fish, modified gelatin, recombinant gelatin, or combinations thereof, polyethylene oxide, polyacrylamide, and the like.

The number of layers is not specifically limited and depends largely on the available technique for application of the layers and the required ink receiving properties of the ink receiving layer one like to achieve. The ink receiving multilayer may be composed of from 2 to 26 and preferably from 2 to 18 sub-layers. In a special embodiment the layer comprising the water soluble polymer which is preferably a (modified) gelatin, and the PVA based polymer which is preferably a PVA-NVF co-polymer, is the layer just below the top layer, touching the top layer.

Preferably, the ratio of PVA-based polymer and water soluble polymer is at least 1:1, more preferably at least 3:2, most preferably at least 2:1.

In addition to the layer(s) comprising a PVA based polymer and a water soluble polymer, it is possible that for certain special applications intermediate layers are present, which intermediate layers comprise a PVA based polymer or a mixture of different PVA based polymers, but which intermediate layer are free (or essentially free) of other water soluble polymers than PVA based polymers. On the other hand, depending on the properties to be achieved, intermediate layers may also be used in addition to the layer(s) comprising PVA-based polymers that comprise water soluble polymers without the use of PVA-based polymers. The water soluble polymers of the intermediate layers not comprising a PVA-based-polymer can be selected from the group of hydroxyethyl cellulose, methyl cellulose, hydroxypropyl cellulose, polyvinylpyrolidone, any gelatin whether lime or acid treated bone or hide gelatin of pig or cattle or fish, modified gelatin, recombinant gelatin, polyethylene oxide, polyacrylamide, and combinations thereof.

The total amount of water soluble polymers ranges preferably from 1.0 to 30 g/m², more preferably from 1.0 to 20 g/m².

In case a modified gelatin is applied as water soluble polymer the modified gelatin which is used together with the PVA-based polymer and the modified gelatin which is used in the top layer can be identical gelatins. There is however no need to use the same kind of modified gelatin both in the intermediate layer together with PVA-based polymer and in the top layer. Also very good results were obtained when both layers comprised non-identical gelatins.

It was found that by providing a medium comprising an ink receiving layer comprising an intermediate layer comprising a PVA based polymer and a modified gelatin in the layer directly underneath the top layer comprising a modified gelatin, oily substances are more or less drawn into the ink receiving layer. This is particularly important for certain types of ink, which can be oily.

The top layer determines the surface properties like beading and gloss. The top layer may further comprise water insoluble particles inter alia to regulate the slip behaviour and optionally one or more water soluble polymers, surfactants and other additives to optimise the surface properties.

Apart from the modified gelatin it may be desirable to add in the top layer an anti-blocking agent to prevent image transfer when several printed inkjet media are stacked. Very suitable anti-blocking agents (also known as matting agents) have a particle size from 1 to 20 μm, preferably between 2 and 10 μm. The amount of matting agent is preferably from 0.01 to 1 g/m², more preferably from 0.01 to 0.5 g/m². The matting agent can be defined as particles of inorganic or organic materials capable of being dispersed in a hydrophilic organic colloid. The inorganic matting agents include oxides such as silicon oxide, titanium oxide, magnesium oxide and aluminium oxide, alkali earth metal salts such as barium sulphate, calcium carbonate, and magnesium sulphate, and glass particles. Besides these substances one may select inorganic matting agents which are disclosed in West German Patent No. 2 529 321, British Patent Nos. 760 775 and 1 260 772, U.S. Pat. Nos. 1,201,905, 2,192,241, 3,053,662, 3,062,649, 3,257,296, 3,322,555, 3,353,958, 3,370,951, 3,411,907, 3,437,484, 3,523,022, 3,615,554, 3,635,714, 3,769,020, 4,021,245 and 4,029,504. The organic matting agents include starch, cellulose esters such as cellulose acetate propionate, cellulose ethers such as ethyl cellulose, and synthetic resins. The synthetic resins are water insoluble or sparingly soluble polymers which include a polymer of an alkyl(meth)acrylate, an alkoxyalkyl(meth)acrylate, a glycidyl(meth)acrylate, a (meth)acrylamide, a vinyl ester such as vinyl acetate, acrylonitrile, an olefin such as ethylene, or styrene and a copolymer of the above described monomer with other monomers such as acrylic acid, methacrylic acid, alpha, beta -unsaturated dicarboxylic acid, hydroxyalkyl(meth)acrylate, sulfoalkyl(meth)acrylate and styrene sulfonic acid. Further, a benzoguanamin-formaldehyde resin, an epoxy resin, nylon, polycarbonates, phenol resins, polyvinyl carbazol or polyvinylidene chloride can be used. Besides the above, organic matting agents can be used, which are disclosed in British Patent No. 1 055 713, U.S. Pat. Nos. 1,939,213, 2,221,873, 2,268,662, 2,322,37, 2,376,005, 2,391,181, 2,701,245, 2,992,101, 3,079,257, 3,262,782, 3,443,946, 3,516,832, 3,539,344, 3,591,379, 3,754,924 and 3,767,448, Japanese Patent O.P.I. Publication Nos. 49-106821/1974 and 57-14835/1982. These matting agents may be used alone or in combination.

A further improvement can be obtained by including in the top layer a fluorosurfactant. It was found that this kind of surfactants improves amongst others the gloss and beading. Beading is defined as the phenomenon that large ink dots become visible on the printed image.

The term “fluorosurfactant” as used herein, refers to surfactants (viz. molecules having a hydrophilic and a hydrophobic part) based on hydrocarbons, which hydrocarbons are substituted with at least one F atom. Suitable fluorosurfactants may be anionic, non-ionic or cationic. Examples of suitable fluorosurfactants are: fluoro C₂-C₁₀ alkylcarboxylic acids and salts thereof, disodium N-perfluorooctanesulfonyl glutamate, sodium 3-(fluoro-C₆-C₁₁ alkylaxy)-1-C₃-C₄ alkyl sulfonates, sodium 3-(omega -fluoro-C₆-C₈ alkanoyl-N-ethylamino)-1-propane sulfonates, N-[3-(perfluorooctanesulfonamide)-propyl]-N,N-dimethyl-N-carboxymethylene ammonium betaine, fluoro-C₁₁-C₂₀ alkylcarboxylic acids and salts thereof, perfluoro alkyl carboxylic acids (e.g. perfluoro C₇-C₁₃ alkyl carboxylic acids) and salts thereof, perfluorooctane sulfonic acid diethanolamide, Li, K and Na perfluoro C₄-C₁₂ alkyl sulfonates, Li, K and Na N-perfluoro C₄-C₁₃ alkane sulfonyl —N— alkyl glycine, Zonyl™ type of fluoro surfactants as supplied by Dupont, N-propyl-N-(2-hydroxyethyl)perfluorooctane sulfonamide, 2-sulfo-1,4-bis(fluoroalkyl)butanedioate, 1,4-bis (fluoroalkyl)-2-[2-N,N,N-trialkylammonium) alkyl amino] butanedioate, perfluoro C₆-C₁₀ alkylsulfonamide propyl sulfonyl glycinates, bis-(N-perfluorooctylsulfonyl-N-ethanolaminoethyl)phosphonate, mono-perfluoro C₆-C₁₆ alkyl-ethyl phosphonates, and perfluoroalkylbetaine. Also useful are the fluorocarbon surfactants described e.g. in U.S. Pat. No. 4,781,985 and in U.S. Pat. No. 5,084,340. Preferably the fluorosurfactant is chosen from Li, K and Na N-perfluoro C₄-C₁₃ alkane sulfonyl —N— alkyl glycine, Zonyl™ surfactants and 1,4-bis (fluoroalkyl)-2-[2-N,N,N-trialkylammonium alkyl amino] butanedioate.

The top layer may optionally include thickener agents, biocides crosslinking agents and further various conventional additives such as colorants, coloured pigments, pigment dispersants, mold lubricants, permeating agents, fixing agents for ink dyes, anti-oxidants, dispersing agents, anti-foaming agents, levelling agents, fluidity improving agents, antiseptic agents brightening agents, viscosity stabilizing and/or enhancing agents, pH adjusting agents, anti-mildew agents, anti-fungal agents, agents for moisture-proofing, agents for increasing the stiffness of wet paper, agents for increasing the stiffness of dry paper and anti-static agents.

The above-mentioned various additives can be added ordinarily in a range of 0 to 10 weight % based on the solid content of the ink receiving layer composition.

The ink receiving layer may further comprise an LTV stabiliser. Any UV stabiliser known in the art can be added. Suitable LTV agents are selected from the group consisting of purine compounds, pyrimidine compounds, benzimidazole compounds, imidazolidine compounds, urazole compounds, pyrazole compounds, triazole compounds, benzotriazole compounds, tetrazole compounds, pyrazine compounds, cinnamate compounds, aminobutadiene compounds and mixtures thereof.

Examples of UV agent are those described in Research Disclosure RD24239, RD290119, RD30326, EP-A 0 673 783, GB-A 2088 777, EP-A 0955180, EP-A-0 738 718, U.S. Pat. No. 4,926,190 and in Ullmann's Encyclopedia of Industrial Chemistry, 5^{th} completely revised edition 1992, volume 20, page 468-471. Other suitable TV agents are compounds containing a triazine skeleton. These compounds are described, for example, in JP-A-46-3335, JP-A-55-152776, JP-A-5-197074, JP-A-5-232630, JP-A-5-307232, JP-A-6-211813, JP-A-8-53427, JP-A-8-234364, JP-A-8-239368, JP-A-9-31067, JP-A-10JP-A-10-147577, JP-10-182621, JP-T-8-501291 (“JP-T” means published searched patent publication). EP-A-0711804 and DE-A-19739797 are preferable.

Preferred UV agents are benzotriazole compounds, such as 2-(2-hydroxy-5′methylphenyl)benzotriazole, 2-(2′-hydroxy-3′,5′-di-t-butylphenyl)benzotriazole, 2-(2′-hydroxy-3′,5′-di-t-butylphenyl)-5-chlorobenzotriazole, 2-(2′-hydroxy-5′-t-butylphenyl)benzotriazole, 2-(2′-hydroxy-5′-t-butylphenyl)-5-chlorobenzotriazole, 2-(2′-hydroxy-3′-sec-butyl-5′-t-butylphenyl)benzotriazole, 2-(2′-hydroxy-3′-sec-butyl-5′-t-butylphenyl)-5-chlorobenzotriazole, 2-(2′-hydroxy-4′-n-hexyloxyphenyl)benzotriazole, 2-(2′-hydroxy-5′-isoocytlphenyl)benzotriazole, 2-(2′-hydroxy-3′,5′-di-t-amylphenyl)benzotriazole, 2-(2′-hydroxy-5′-isooctylphenyl)-5′-methyl-benzotriazole, 2-(2′-hydroxy-3′,5′-di-t-amylphenyl) benzotriazole, 2-(2′-hydroxy-3′-t-butyl-5′mehtylphenyl)benzotriazole, 2-(2′-hydroxy-3′-sec-dodecyl-5′mehtylphenyl) benzotriazole, as well as the benzotriazole compounds described in EP-A-0 738 718, the benzotriazole compounds described in U.S. Pat. No. 4,926,190, and mixtures thereof. The TV agent can be added dissolved in a suitable solvent or as a component of an oil in water emulsion. Also gelatin modified with an UV agent can be used.

The UV agent may be added in the amount from 0.03 g/m² to 10 g/m², preferable between 0.03 g/m² and 5 g/m².

The ink receiving layer may further comprise:
An optical brightener. Suitable optical brighteners are disclosed in e.g. RD11125, RD9310, RD8727, RD8407, RD36544 or Ullmann's Encyclopedia of Industrial Chemistry (Vol. A18 pp. 153-167), and comprise thiophenes, stilbenes, triazines, imidazolones, pyrazolines, triazoles, bis(benzoxazoles), coumarins and acetylenes. The optical brightener can be added dissolved in a suitable solvent or as a component in an oil in water emulsion. Also gelatin modified with an optical brightener can be used. The optical brightener may be present in the ink receiving layer in an amount of 0.01 to 5.0 gram/m², preferably of 0.02 to 1.0 gram/m².
One or more plasticizers, such as ethylene glycol, diethylene glycol, propylene glycol, polyethylene glycol, glycerol monomethylether, glycerol monochlorohydrin, ethylene carbonate, propylene carbonate, tetrachlorophthalic anhydride, tetrabromophthalic anhydride, urea phosphate, triphenylphosphate, glycerolmonostearate, propylene glycol monostearate, tetramethylene sulfone, N-methyl-2-pyrrolidone, N-vinyl-2-pyrrolidone, and polymer lattices with low Tg-value such as polyethylacrylate, polymethylacrylate and the like.
One or more fillers; both organic and inorganic particles can be used as fillers. Useful filler examples are represented by silica (colloidal silica), alumina or alumina hydrate (aluminazol, colloidal alumina, a cat ion aluminum oxide or its hydrate and pseudo-boehmite), a surface-processed cat ion colloidal silica, aluminum silicate, magnesium silicate, magnesium carbonate, titanium dioxide, zinc oxide, calcium carbonate, kaolin, talc, clay, zinc carbonate, satin white, diatomaceous earth, synthetic amorphous silica, aluminum hydroxide, lithopone, zeolite, magnesium hydroxide and synthetic mica. Useful examples of organic fillers are represented by polystyrene, polymethacrylate, polymethyl-methacrylate, elastomers, ethylene-vinyl acetate copolymers, polyesters, polyester-copolymers, polyacrylates, polyvinylethers, polyamides, polyolefins, polysilicones, guanamine resins, polytetrafluoroethylene, elastomeric styrene-butadiene rubber (SBR), urea resins, urea-formalin resins. Such organic and inorganic fillers may be used alone or in combination.
One or more mordants. Mordants may be incorporated in the ink-receptive layer of the present invention. Such mordants are represented by cationic compounds, monomeric or polymeric, capable of complexing with the dyes used in the ink compositions. Useful examples of such mordants include quaternary ammonium block copolymers. Other suitable mordants comprise diamino alkanes, ammonium quaternary salts and quaternary acrylic copolymer latexes. Other suitable mordants are fluoro compounds, such as tetra ammonium fluoride hydrate, 2,2,2-trifluoroethylamine hydrochloride, 1-(alpha, alpha, alpha -trifluoro-m-tolyl) piperazine hydrochloride, 4-bromo- alpha, alpha, alpha -trifluoro-o-toluidine hydrochloride, difluorophenylhydrazine hydrochloride, 4-fluorobenzylamine hydrochloride, 4-fluoro- alpha, alpha -dimethylphenethylamine hydrochloride, 2-fluoroethylaminehydrochloride, 2-fluoro-1-methylpyridinium-toluene sulfonate, 4-fluorophenethylamine hydrochloride, fluorophenylhydrazine hydrochloride, 1-(2-fluorophenyl) piperazine monohydrochloride, 1-fluoro pyridinium trifluoromethane sulfonate.
One ore more additives, such as:
pigments: white pigments such as titanium oxide, zinc oxide, talc, calcium carbonate and the like; blue pigments or dyes such as cobalt blue, ultramarine or phthalocyanine blue; magenta pigments or dyes such as cobalt violet, fast violet or manganese violet;
biocides;
pH controllers;
preservatives;
viscosity modifiers;
dispersing agents;
anti-oxidants;
antistatic agents; and/or
anionic, cationic, non-ionic, and/or amphoteric surfactants, typically used in amounts ranging from 0.1 to 1000 mg/m², preferably from 0.5 to 100 mg/m².

These additives may be selected from known compounds and materials in accordance with the objects to be achieved.

The above-mentioned additives (plasticizers, fillers/pigments, mordants, conventional additives) may be added in a range of 0 to 30% by weight of total additive, based on the solid content of the water soluble polymers and PVA-based polymers in the ink receiving layer.

The particle sizes of the non water-soluble particulate additives should not be too high, since otherwise a negative influence on the resulting surface will be obtained. The used particle size should therefore preferably be less than 10 μm, more preferably 7 μm or less. The particle size is preferably above 0.1 μm, more preferably about 1 μm or more for handling purposes.

If desired, the water soluble polymer and/or the PVA based polymer can be cross-linked in the image-recording elements of the present invention in order to impart mechanical strength to the layer. This can be done by any cross-linking agent known in the art.

For gelatin, there is a large number of known cross-linking agents—also known as hardening agents. Examples of the hardener include aldehyde compounds such as formaldehyde and glutaraldehyde, ketone compounds such as diacetyl and chloropentanedion, bis (2-chloroethylurea), 2-hydroxy-4,6-dichloro-1,3,5-triazine, reactive halogen-containing compounds disclosed in U.S. Pat. No. 3,288,775, carbamoyl pyridinium compounds in which the pyridine ring carries a sulphate or an alkyl sulphate group disclosed in U.S. Pat. No. 4,063,952 and U.S. Pat. No. 5,529,892, divinylsulfones, and the like. These hardeners can be used singly or in combination. The amount of hardener used, preferably ranges from 0.1 to 10 g, and more preferably from 0.1 to 7 g based on 100 g of gelatin contained in the ink-receiving layer. For PVA-based polymers, for example, it is preferable to choose a cross-linking agent selected from borax, glyoxal, dicarboxylic acids and the like.

The modified gelatin(s) are used in an amount preferably from 0.1 until 5.0 g/m², more preferably from 0.2 until 4.0 g/m². If the modified gelatin is only used in the top layer the preferred amount of modified gelatin in the top layer ranges from 0.1 to 2 g/m² and more preferably from 0.2 to 1.0 g/m².

A process for providing the inkjet media of the present invention comprises the steps of providing a support and applying the formulation for the top layer, comprising a modified gelatin, and the formulation for the intermediate layer(s), comprising a water soluble polymer and a PVA based polymer, consecutively or simultaneously by any method known in the art. The coating methods are for example, a curtain coating, an extrusion coating, an air-knife coating, a slide coating, a roll coating method, reverse roll coating, dip coating processes and a rod bar coating. The preparation of the formulations of top layer and intermediate layer(s) is done via methods known to those in the art. Generally the various water soluble polymers are dissolved separately in water at elevated temperatures, between 30 and 80° C. after which the homogeneous solutions are mixed, resulting in a homogeneous mixture which mixture is than completed by adding the other required components and stirring at ambient temperature or elevated temperatures to give the final homogeneous mixture which is ready for coating.

Generally it will be necessary to coat one or more layers on the backside of the support, i.e. the side of the support opposite to the side coated with the ink receiving layer, for instance to optimise the curling behaviour of the medium especially, which curling may occur at low humidity conditions due to contraction of the polymers during drying. The backside coating typically comprises gelatin or a water soluble polymer in an amount ranging preferably from 1 to 20 g/m², more preferably from 4 to 15 g/m², even more preferably from 5 to 13.5 g/m². The optimum amount of the backside coating depends on the type of gelatin, the type of water soluble polymer and on the composition of the layers at the ink receiving side of the medium. The preferred polymer for the backside coating is gelatin. In a special embodiment also on the backside an ink receiving layer is coated creating a medium which is printable on both sides.

As stated above, the top layer determines for a large part the gloss of the resulting recording medium and the printed image on the medium. Surprisingly it has been found that the gloss of the recording medium can be improved further by selecting the appropriate surface roughness of the used support. It was found, that providing a support having a surface roughness characterised by the value Ra being less than 1.0 μm, preferably below 0.8 μm a very glossy recording medium can be obtained. The Ra is measured according to DIN 4776 by a UBM laserprofilometer, software package version 1.62 with the following settings:

(1) Point density 500 P/mm (2) Area 5.6×4.0 mm² (3) Cut-off wavelength 0.80 mm (4) Speed 0.5 mm/sec.

The base paper to be used as the support for the present invention is selected from materials conventionally used in high quality printing paper. Generally it is based on natural wood pulp and if desired, a filler such as talc, calcium carbonate, TiO₂, BaSO₄, and the like can be added. Generally the paper also contains internal sizing agents, such as alkyl ketene dimer, higher fatty acids, paraffin wax, alkenylsuccinic acid, epichlorhydrin fatty acid amid and the like. Further the paper may contain wet and dry strength agents such as polyamine, polyamide, polyacrylamide, poly-epichlorhydrin or starch. Further additives in the paper can be fixing agents, such as aluminium sulphate, starch, cationic polymer and the like. The Ra value for a normal grade base paper is well above 1.0 μm typically above 1.3 μm. In order to obtain a base paper with a Ra value below 1.0 μm such a normal grade base paper can be coated with a pigment. Any pigment can be used. Examples of pigments are calcium-carbonate, TiO₂, BaSO₄, clay, such as kaolin, styrene-acrylic copolymer, Mg—Al-silicate, and the like, or combinations thereof. The amount being between 0.5 and 35.0 g/m² more preferably between 0.5 and 20 g/m². This pigmented coating can be applied as a pigment slurry in water together with suitable binders like styrene-butadiene latex, methyl methacrylate-butadiene latex, polyvinyl alcohol, modified starch, polyacrylate latex or combinations thereof, by any technique known in the art, like dip coating, roll coating, blade or bar coating. The pigment coated base paper may optionally be calendered. The surface roughness can be influenced by the kind of pigment used and by a combination of pigment and calendering. The base pigment coated paper substrate has preferably a surface roughness below 1.0 μm, more preferably below 0.8 μm.

The ink receiving multilayer of the present invention can be directly applied to the pigment coated base paper. In another embodiment, the pigment coated base paper having a pigmented top side and a non pigmented back-side is provided on both sides with a polymer resin trough high temperature co-extrusion giving a laminated pigment coated base paper. Typically temperatures in this (co)extrusion are above 280° C. but below 350° C. The preferred polymers used are poly olefins, particularly polyethylene. In a preferred embodiment the polymer resin of the top side comprises compounds such as an opacifying white pigment e.g. TiO₂ (anatase or rutile), ZnO or ZnS, dyes, coloured pigments, adhesion promoters, optical brighteners, antioxidant and the like to improve the whiteness of the laminated pigment coated base paper. By using other than white pigments a variety of colours of the laminated pigment coated base paper can be obtained. The total weight of the laminated pigment coated base paper is between 80 and 350 g/m² The laminated pigment coated base paper shows a very good smoothness, which after applying the ink receiving layer of the present invention results in recording media with excellent gloss.

Other supports used in this invention may suitably be selected from, a synthetic paper or a plastic film in which the top and back coatings are balanced in order to minimise the curl behaviour.

Examples of the material of the plastic film are polyolefin's such as polyethylene and polypropylene, vinyl copolymers such as polyvinyl acetate, polyvinyl chloride and polystyrene, polyamide such as 6,6-nylon and 6-nylon, polyesters such as polyethylene terephthalate, polyethylene-2 and 6-naphthalate and polycarbonate, and cellulose acetates such as cellulose triacetate and cellulose diacetate. The support may have a gelatin subbing layer to improve coatability of the support. The support may be subjected to a corona treatment in order to improve the adhesion between the support and the ink receiving layer. Also other techniques, like plasma treatment can be used to improve the adhesion.

The ink-receiving layer preferably has a dry thickness from 1 to 50 micrometers, more preferably from 5 to 30 micrometers. If the thickness of said ink receiving layer is less than 1 micrometer, adequate absorption of the solvent will not be obtained. If, on the other hand, the thickness of said ink receiving layer exceeds 50 micrometers, no further increase in solvent absorptivity will be gained.

The recording medium of the invention can be used for forming a permanent, precise inkjet image by bringing ink into contact with the medium in the pattern of a desired image.

The recording medium of this invention can be used in any printing application, where a photographic quality print is required. Although the invention is described herein with particular reference to inkjet printing, it will be apparent to the skilled person that the high quality recording media of the present invention are not limited to inkjet recording media (viz. media suitable to be printed on using inkjet printers), but that it is within the scope of the present invention to provide recording media that are suitable for creating high quality images by using other techniques as well, such as Giclée printing, colour copying, screen printing, gravure, dye-sublimation, flexography, xerography, and the like.

The media of the present invention display an excellent light fastness, or dye stability, after exposure to (ambient) light. Light fastness may be assessed by the protocol set out in the examples herein below. Typically, the media of the present invention have more than 80% remaining density.

Furthermore, the media of the present invention have a very high gloss.

The present invention will be illustrated in detail by the following non-limiting examples. Unless stated otherwise, all ratios given are based on weight.

### EXAMPLES

The following examples are illustrative of the invention and are not to be considered as limiting to the present invention. In the following examples, the amounts of ingredients are based on weight, unless stated otherwise.

A. Preparation of a Lime Bone Gelatin Solution-A

A solution containing 100 weight parts of lime bone gelatin of PB Tessenderlo with an IEP of 5.0 and 900 weight parts of water was prepared at 40° C. The pH of the solution was adjusted to 8.5 by adding NaOH.

B. Preparation of the Modified Gelatin Solution-B

A solution containing 100 weight parts of modified gelatin (dodecenyl-succinic modified acid treated gelatin from Stoess GmbH, Germany; modification grade 40%) having an IEP of 5.4 and 900 weight parts of water was prepared at 40° C. The pH of the solution was adjusted to 8.5 by adding NaOH.

C. Preparation of the PVP Solution-C

A solution containing 100 weight parts of polyvinyl pyrollidone (PVP) having molecular weight of about 30 000 Daltons (ICN Biochemicals) and 900 weight parts of water was prepared at 40° C. The pH of the solution was adjusted to 9 by adding NaOH.

D. Preparation of the Modified PVA Solution-D

A solution containing 100 weight parts of PVA-NVF co polymer (CGPS-910, melting range 210-230° C., CIBA Specialty Chemicals) and 900 weight parts of water was prepared at 85° C. The pH of the solution was adjusted to 9 by adding NaOH.

E. Preparation of the PVA Solution-E

A solution containing 100 weight parts of PVA (Mowiol® 8-88, Kuraray Specialties Europe) and 900 weight parts of water was prepared at 85° C. The pH of the solution was adjusted to 9 by adding NaOH.

Examples 1-6: set of experiments in which the ink receiving layer comprises one top layer and two intermediate layers.

Layer Structure

Various recording media were produced by applying three layers on a substrate. Each layer was applied in the indicated amounts, which indicate the total solid content after drying.

Top layer: 1 g/m²
Intermediate layer 1: 5 g/m²
Intermediate layer 2: 7 g/m²
Photographic grade paper with
polyethylene laminated on both
sides (Laminated Substrate)

### Example 1 (Comparative)

For the top layer, 1 weight part of Zonyl® FSA surfactant (a fluoro-carbon type of surfactant) was added to 1000 weight parts of Solution-A to provide a good wettability.

In this example Intermediate layers 1 and 2 from the scheme hereinabove were combined as a single intermediate layer of 12 g/m². Solution-A was used for this intermediate layer as it was.

The compositions, for the top layer and the intermediate layer, were fed into a slide coating machine, commonly known in the photographic industry, and coated on the laminated substrate. The flow was adjusted such that, after drying, the total solid content of the top layer was 1.0 g/m² and that of the combined intermediate layers 1 and 2 (=gelatin+other water soluble polymer) was 12.0 g/m².

After coating, the coated material was chilled at a temperature of ca. 12° C. to set the gelatin and then dried with dry air at a maximum temperature of 40° C.

### Example 2 (Comparative)

For the top layer, 1 weight part of Zonyl® FSA surfactant (a fluoro-carbon type of surfactant) was added to 1000 weight parts of Solution-B to impart a good wettability. In this example Intermediate layers 1 and 2 from the scheme hereinabove were combined as a single intermediate layer of 12 g/m². Solution-A was used for this intermediate layer as it was. The compositions were fed into a slide coating machine, commonly known in the photographic industry, and coated on the laminated substrate. The flows were adjusted such that, after drying, the total solid contents indicated in the scheme hereinabove were obtained.

After coating, the coated material was chilled at a temperature of ca. 12° C. to set the gelatin and then dried with dry air at a maximum temperature of 40° C.

### Example 3 (Comparative)

The ink receiving layers were produced in the same manner as in Example 1, except that, in intermediate layer 1 a 40:60 mixture of Solution-B and Solution-D was used, and a 85:15 mixture of Solution-B and Solution-C was used in the Intermediate layer 2.

### Example 4 (Inventive)

The ink receiving layers were produced in the same manner as in Example 2, except that a 40:60 mixture of Solution-A and Solution-D was used in the Intermediate layer 1, and the 85:15 mixture of Solution-A and Solution-C was used in the Intermediate layer 2.

### Example 5 (Comparative)

The ink receiving layers were produced in the same manner as in Example 1, except that the 40:60 mixture of Solution-A and Solution-E was used in the Intermediate layer 1, and the 85:15 mixture of Solution-A and Solution-C was used in the Intermediate layer 2.

### Example 6 (Inventive)

The ink receiving layers were produced in the same manner as in Example 2, except that a 40:60 mixture of Solution-B and Solution-D was used in the Intermediate layer 1, and the 85:15 mixture of Solution-A and Solution-C was used in the Intermediate layer 2.

Evaluation

The ink jet media prepared by the above mentioned formulation and said coating process, were printed with a standard image comprising black, cyan, magenta and yellow bars. The image contained also two pictures; including a portrait picture and a composition picture. The image was printed at a room conditions (23° C. and 48% Relative Humidity (RH)) and the printed materials were kept at this condition for at least 1 hour to dry.

A HP Deskjet® 5650 was used to print the images by using the following settings:

Print quality: best.

Selected Paper type: HP premium plus photo paper, glossy.

Other parameters were according to the factory setting.

The quality of the printed images was analysed visually by analysing the light fastness behaviour, the glossiness of especially the black area, the dryness of especially the black area, and on haze in black.

Raw Gloss

Raw gloss is a glossiness of coated composition without print.

The glossiness was measured by a REFLEKTOMETER, REFO 3-D gloss meter (Dr. Lange) and evaluated according to the following criteria.

O: glossiness of 20°>=70%

Δ: glossiness of 20° is between 40% and 70%

X: glossiness of 20°<40%

Haze in Black

Haze in black is a hazy appearance in ‘black’ printed parts (or dark coloured high density parts) after drying. It depends on the printer's ink composition and especially on the amount of ink used. The haze in black can be observed independent from the way how the black is obtained, whether by mixing cyan, magenta, and yellow inks, or directly printing black ink.

The glossiness of the image directly after printing and after two days were analysed by observing the reflection of light on the high density area of the print (e.g. black colour). The more reflection was observed, the glossier the printed image. The following classification was defined for judging the Glossiness:

O: Still glossy after 2 days without any defects.

Δ: Slightly hazy after drying, but acceptable.

X: Matte appearance after printing, or severely hazy after drying.

Light Fastness

Light fastness is a measure for the dye stability during the display or storage at (ambient) light conditions. In order to evaluate this behaviour a sample was dried for one week after printing at ambient temperature and humidity and subsequently exposed for 504 hrs using a xenon light (85 000 lx) in an Atlas Wether-O-Meter C I 35A, (manufactured by Atlas (Illinois, U.S.A.)). Using a cycle of 228 min. light on with a temperature of 40° C. and a relative humidity (RH) of 24% and a period of 60 min. light off at a temperature of 27° C. and a RH of 40%. The image density of the colour on the printed area is measured before and after the xenon exposure and was measured by a reflection densitometer (X-Rite 310TR) and evaluated as the dye residual percentage. The overall performance of the light fading properties is judged based on the loss of image density of the cyan, magenta and yellow colours and on the neutrality of the grey tone. The following classification has been defined:

O: good

Δ: acceptable

X: not acceptable

Drying Speed

Directly after printing the standard pattern, a white plain paper was overlaid on the printed sheet and a stainless steel roller with a weight of 10 kg was rolled over the white paper slowly. The drying speed of the ink-jet sheet was determined by analysing visually the colour density of the print which was transferred to the white paper. A lower density at the white paper means a better drying speed of the ink-jet solvent.

Definition:

O=Good

Δ=Not totally dry but still acceptable

X=Not acceptable

All results are summarized in Table-1.

TABLE 1

| | Composition of layers | | | Evaluation results | | | |
|---|---|---|---|---|---|---|---|
| | Top | 1^{st} | 2^{nd} | | haze | | |
| | layer | intermediate | intermediate | raw | in | light | drying |
| Example | 1 g/m² | layer 5.0 g/m² | layer 7.0 g/m² | gloss | black | fastness | speed |
| 1 | Normal | Normal gelatin | | ο | X | X | ο |
| | gelatin | | | | | | |
| 2 | Modified | Normal gelatin | | ο | Δ | X | ο |
| | gelatin | | | | | | |
| 3 | Normal | Modified | Modified | ο | X-Δ | Δ-ο | ο |
| | gelatin | gelatin + modified | gelatin + PVP | | | | |
| | | PVA | | | | | |
| | | (2:3) | | | | | |
| 4 | Modified | Normal | Normal | ο | Δ | Δ-ο | ο |
| | gelatin | gelatin + modified | gelatin + PVP | | | | |
| | | PVA | | | | | |
| | | (2:3) | | | | | |
| 5 | Normal | Normal | Normal | X-Δ | X | Δ-ο | ο |
| | gelatin | gelatin + Normal | gelatin + PVP | | | | |
| | | PVA | | | | | |
| | | (2:3) | | | | | |
| 6 | Modified | Modified | Normal | ο | ο | Δ-ο | ο |
| | gelatin | gelatin + modified | gelatin + PVP | | | | |
| | | PVA | | | | | |
| | | (2:3) | | | | | |

The results as displayed in table 1 show that modified gelatin in the top layer enhances the performance in relation to haze in black. The presence of a PVA based polymer in the 1^{st} intermediate layer very much improves the light fastness.

Examples 7-13: set of experiments in which the ink receiving layer comprises one top layer and one intermediate layer.

Schematic Drawing and Definition of the Layer Structure

Top layer
Intermediate layer
Laminated Support

### Example 7 (Comparative)

To 1000 weight parts of Solution-A was added 1 weight part of Zonyl® FSA surfactant (a fluoro-carbon type of surfactant) to provide a good wettability.

The composition, for the production of only one layer, was fed into a slide coating machine, commonly known in the photographic industry, and coated on a photographic grade paper having polyethylene laminated at both sides (laminated support). The flow was adjusted such that, after drying, the total solid content of the layer (i.e., gelatin content) was 10 g/m².

After coating, the coated material was chilled at a temperature of ca. 12° C. to set the gelatin and then dried with dry air at a maximum temperature of 40° C.

### Example 8 (Comparative)

For the top layer, to 1000 weight parts of Solution-A was added 1 weight part of Zonyl® FSA surfactant to impart a good wettability. Solution-B was used in the 2^{nd} (intermediate) layer.

The compositions were fed into a slide coating machine, commonly known in the photographic industry, and coated on a photographic grade paper having polyethylene laminated at both sides (laminated support). The flows were adjusted such that, after drying, the total solid content of the intermediate layer(s) (=gelatin+other water soluble polymer) was 9 g/m² and that of the top layer was 1 g/m².

After coating, the coated material was chilled at a temperature of ca. 12° C. to set the gelatin and then dried with dry air at a maximum temperature of 40° C.

### Example 9 (Comparative)

The ink receiving layers were produced in the same manner as in Example 8, except that a 2:3 mixture of Solution-A and Solution-D was used in the intermediate layer.

### Example 10 (Comparative)

The ink receiving layers were produced in the same manner as in Example 8, except that a 2:3 mixture of Solution-B and Solution-D was used in the intermediate layer.

### Example 11 (comparative)

The ink receiving layers were produced in the same manner as in Example 7, except that a 2:3 mixture of Solution-A and Solution-D was used in stead of Solution-A.

### Example 12 (Inventive)

The ink receiving layers were produced in the same manner as in Example 8, except that Solution-B was used for the top layer and a 2:3 mixture of Solution-A and Solution-D was used in the intermediate layer.

### Example 13 (Inventive)

The ink receiving layers were produced in the same manner as in Example 8, except that Solution-B was used for the top layer and a 2:3 mixture of Solution-B and Solution-D was used in the intermediate layer.

### Example 14 (Inventive)

The ink receiving layers were produced in the same manner as in Example 8, except that Solution-B was used for the top layer and a 1:2 mixture of Solution-B and Solution-D was used in the intermediate layer.

TABLE 2

| | Contents of layers | | Evaluation results | | | |
|---|---|---|---|---|---|---|
| | | intermediate | | haze | | |
| | Top layer | layer | raw | in | light | Drying |
| Example | 1 g/m² | 9 g/m² | gloss | black | fastness | speed |
| 7 | Normal | Normal gelatin | ο | X | X | ο |
| | gelatin | | | | | |
| 8 | Normal | Modified gelatin | ο | X-Δ | X | ο |
| | gelatin | | | | | |
| 9 | Normal | Normal gelatin + modified | ο | X | Δ-ο | ο |
| | gelatin | PVA | | | | |
| | | (2:3) | | | | |
| 10 | Normal | Modified gelatin + modified | ο | X-Δ | Δ-ο | ο |
| | gelatin | PVA | | | | |
| | | (2:3) | | | | |
| 11 | Normal | Normal gelatin + modified | X | X | Δ-ο | ο |
| | gelatin + modified | PVA | | | | |
| | PVA | (2:3) | | | | |
| 12 | Modified | Normal gelatin + modified | ο | Δ | Δ-ο | ο |
| | gelatin | PVA | | | | |
| | | (2:3) | | | | |
| 13 | Modified | Modified gelatin + modified | ο | ο | Δ-ο | ο |
| | gelatin | PVA | | | | |
| | | (2:3) | | | | |
| 14 | Modified | Modified gelatin + modified | ο | ο | ο | ο |
| | gelatin | PVA | | | | |
| | | (1:2) | | | | |

The results shown in the table above illustrate that an ink receiving layer containing gelatin exhibits a poor light fastness which is improved by including a PVA based polymer into the intermediate layer. When a PVA based polymer is present in the top layer mixed with normal gelatin the gloss is not acceptable. The best results are obtained with a high ratio of modified PVA and (modified) gelatin, e.g. a ratio of 2:1.

1. A recording medium comprising a support and an ink-receiving layer adhered to said support, wherein the ink-receiving layer is a multilayer comprising a top layer, which top layer comprises a modified gelatin, and at least one intermediate layer in between said support and said top layer, wherein said intermediate layer comprises a mixture of a poly vinyl alcohol (PVA)-based polymer and a water soluble polymer.

2. The recording medium according to claim 1, wherein said PVA-based polymer is selected from the group consisting of fully hydrolysed or partially hydrolysed PVA, carboxylated PVA, acetoacetylated PVA, quaternary ammonium modified PVA, copolymers and terpolymers of PVA with other polymers, and combinations thereof.

3. The recording medium according to claim 1, wherein said water soluble polymer is selected from the group consisting of fully hydrolysed or partially hydrolysed polyvinyl alcohol, hydroxyethyl cellulose, methyl cellulose, hydroxypropyl cellulose, polyvinylpyrolidone, any gelatin whether lime or acid treated bone or hide gelatin of pig or cattle or fish, modified gelatin, recombinant gelatin, polyethylene oxide, polyacrylamide, and combinations thereof.

4. The recording medium according to claim 1, wherein said at least one intermediate layer comprising a mixture of a PVA-based polymer and a water soluble polymer is the first layer under the top layer.

5. The recording medium according to claim 1, wherein said water soluble polymer is a modified gelatin.

6. The recording medium according to claim 1, wherein said modified gelatin is selected from the group consisting of acetylated gelatin, phthalated gelatin, alkyl quaternary ammonium modified gelatin, succinated gelatin, alkylsuccinated gelatin, gelatin chemically modified with N-hydroxysuccinimide ester of fatty acid, and combinations thereof.

7. The recording medium according to claim 1, wherein said modified gelatin is dodecenylsuccinic acid modified gelatin in which at least 30% of the NH₂ groups of the gelatin have been modified with said dodecenylsuccinic acid.

8. The recording medium according to claim 5, wherein the modified gelatin of the top layer and the modified gelatin of the intermediate layer are identical.

9. The recording medium according to claim 5, wherein the modified gelatin from the top layer and the modified gelatin of the intermediate layer are not identical.

10. The recording medium according to claim 1 in which the modified gelatin is used in an amount of 0.1 to 5.0 g/m².

11. The recording medium according to claim 1, wherein said PVA-based polymer is a PVA-NVF polymer according to formula I: 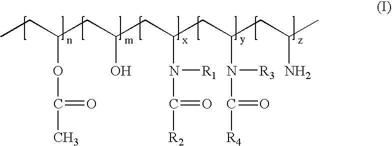
wherein
n is between 0 and 20 mole percent;
m is between about 50 and 97 mole percent;
x is between 0 and 20 mole percent;
y is between 0 and 20 mole percent;
z is between 0 and 2 mole percent and
x+y is between about 3 and 20 mole percent;
R₁, and R₃ are independently H, 3-propionic acid or C₁-C₆ alkyl ester thereof, or is 2-methyl-3-propionic acid or C₁-C₆ alkyl ester thereof; and
R₂ and R₄ are independently H or C₁-C₆ alkyl.

12. The recording medium according to claim 1, wherein said PVA based polymer is used in an amount of 0.5 to 15.0 g/m².

13. The recording medium according to claim 1, wherein the ink receiving layer in addition to the intermediate layer comprising a PVA-based polymer further comprises one or more layers comprising a water soluble polymer selected from the group of hydroxyethyl cellulose, methyl cellulose, hydroxypropyl cellulose, polyvinylpyrolidone, any gelatin whether lime or acid treated bone or hide gelatin of pig or cattle or fish, modified gelatin, recombinant gelatin, polyethylene oxide, polyacrylamide, and combinations thereof.

14. The recording medium according to claim 1 in which the number of layers of said multilayer is from 2 to 26.

15. The recording medium according to claim 1, where the multilayer further comprises an UV absorbing agent, an anti-oxidant, an optical brightener, a light stabilizer, a radical scavenger, a surfactant, a fluoro surfactant and/or combinations thereof.

16. The recording medium according to claim 1, where the support is selected from a paper, a base paper, a pigment coated base paper, a laminated pigment coated base paper, a laminated paper, a synthetic paper or a film substrate.

17. The recording medium according to claim 1, where the support has a surface roughness Ra, as determined according to DIN 4776, smaller than 1.0.

18. A process for preparing a recording medium, comprising the steps of:
providing at least a first and a second solution,
the first solution comprising a modified gelatin for the top layer of said medium;
the second solution comprising a water soluble polymer and a PVA based polymer;
followed by a step wherein said solutions are applied to a support to provide a medium having at least one top layer comprising the modified gelatin from the first solution and at least one layer located in between said top layer and said support comprising the water soluble polymer and the PVA based polymer from the second solution.

19. A method of forming a permanent, precise ink-jet image comprising the steps of:
providing a recording medium as defined in claim 1,
and bringing ink-jet ink into contact with the medium in the pattern of a desired image.

20. The recording medium according to claim 1 in which the modified gelatin is used in an amount of from 0.2 to 4.0 g/m².

21. The recording medium according to claim 1, wherein said PVA based polymer is used in an amount of from 1.0 to 10.0 g/m².

22. The recording medium according to claim 1, in which the number of layers of said multilayer is from 2 to 18.

23. The recording medium according to claim 1, where the support has a surface roughness Ra, as determined according to DIN 4776, smaller than 0.8.
